(19) United States
(12) Patent Application Publication
(10) Pub. No.: US 2010/0161552 A1
(43) Pub. Date: Jun. 24, 2010

(54) METHOD AND SYSTEM FOR REFERENCING MEASURES BETWEEN TABLES OF ANALYTICAL REPORT DOCUMENTS

(76) Inventors: DAN MURARASU, Paris (FR); Sebastien Ducaule, Pontoise (FR)

Correspondence Address: SAP AG, 3410 HILLVIEW AVENUE, PALO ALTO, CA, 94304, US

(21) Appl. No.: 12/343,479

(22) Filed: Dec. 24, 2008

(51) Int. Cl. G06F 17/30

(52) U.S. Cl. 707/610; 707/E17.005; 707/E17.009

(57) ABSTRACT

A method and system for referencing measures between tables of analytical report documents are provided. It is determined whether a source key of a source table and a target key of a target table are on compatible flows, each of the source table and the target table comprising at least one dimension column and one measure column. The source key is a combination of one or more dimensions in the source table and the target key is a combination of one or more dimensions in the target table. On determining that the source key and the target key are not on incompatible flows, the source key is projected on the intersection of the source key and the target key. Finally the target table is synchronized with the source table.

### TECHNICAL FIELD

Embodiments of the invention generally relate to computer systems, and more particularly to a method and system for referencing measures between tables of analytical report documents.

### BACKGROUND

Report blocks in tables of analytical report documents are frequently defined by complex formulas and expressions. A report block is the basic unit of a table in an analytical report document and is specified by a single formula or by a data object. For example each column of a table is represented by a single report block containing a single formula or data object to be calculated and displayed for each table row. Sometimes results or measures from one report block are relevant to calculations in other report blocks. Spreadsheet applications typically allow referencing of results from one cell into other cells of a spreadsheet. Referencing results between report blocks of an analytical report document is far more complex due to constraints of analytical report data such as dependencies between dimensions and measure and data flow compatibilities. Current systems and methods do not provide for the referencing of results between report blocks. The referencing of measures calculated in one report block in other report blocks of an analytical report document may decrease the complexity of defining formulas or expressions to a great extent.

### SUMMARY OF THE INVENTION

Embodiments of the invention are generally directed to methods and systems for referencing measures between tables of analytical report documents. It is determined whether a source key of a source table and a target key of a target table are on compatible flows, each of the source table and the target table comprising at least one dimension column and one measure column. The source key is a combination of one or more dimensions in the source table and the target key is a combination of one or more dimensions in the target table. On determining that the source key and the target key are not on incompatible flows, the source key is projected on the intersection of the source key and the target key. Finally the target table is synchronized with the source table.

Additional features and advantages will be made apparent from the following detailed description of illustrated embodiments, which proceeds with reference to the accompanying drawings.

### BRIEF DESCRIPTION OF THE DRAWINGS

The claims set forth the embodiments of the invention with particularity. The embodiments of the invention, together with its advantages, may be best understood from the following detailed description taken in conjunction with the accompanying drawings. The invention is illustrated by way of example and not by way of limitation in the figures of the accompanying drawings. It should be noted that references to “an” or “one” embodiment in this disclosure are not necessarily to the same embodiment, and such references mean at least one.

FIG. 1 is a block diagram illustrating an exemplary method of referencing a measure between two tables of an analytical report document when the source key and the target key are on compatible flows according to an embodiment of the invention.

FIG. 2 illustrates referencing a measure between two tables of an analytical report document when the source key and the target key are not on compatible flows according to an embodiment of the invention.

FIG. 3 illustrates a logic flow diagram illustrative of operations for referencing a measure between two tables of an analytical report document according to an embodiment of the invention.

FIG. 4 depicts a pictorial representation of a data processing system which can be utilized in accordance with an embodiment of the invention.

### DETAILED DESCRIPTION

Embodiments of the invention are generally directed to methods and systems for referencing measures between tables of analytical report documents. It is determined whether a source key of a source table and a target key of a target table are on compatible flows, each of the source table and the target table comprising at least one dimension column and one measure column. The source key is a combination of one or more dimensions in the source table and the target key is a combination of one or more dimensions in the target table. On determining that the source key and the target key are not on incompatible flows, the source key is projected on the intersection of the source key and the target key. Finally the target table is synchronized with the source table.

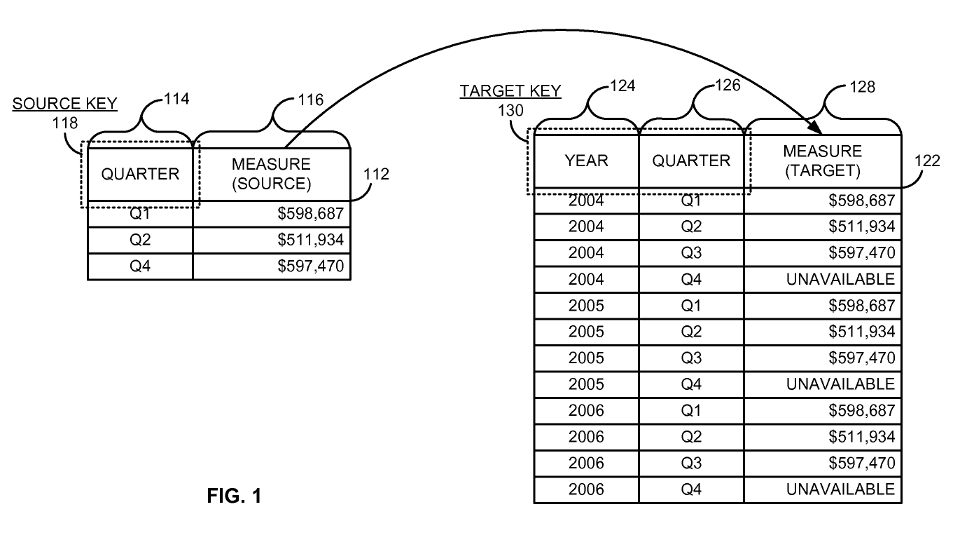

FIG. 1 is a block diagram illustrating an exemplary method of referencing a measure between two tables of an analytical report document when the source key and the target key are on compatible flows according to an embodiment of the invention. Table 112 and table 122 are part of one or more analytical report documents. An analytical report document may include multiple reports typically accessible via a tabbed interface. Every report of an analytical report document may include a table having at least one dimension column and one measure column. Dimensions and measures cannot be put together in one table at random without any dependencies existing between the dimensions and measures. The dependencies between the dimensions and measures are typically deduced based on a database schema defined in a semantic layer. Measures usually depend on dimensions and may be aggregated (summed up) if a projection is done by removing one or more dimensions from the table.

Table 112 includes a column for dimension “Quarter” 114 and a column that shows a measure 116 for the average dollar value of a quantity sold. Data in every table of an analytical report document generally represents a portion of data from a database that is pulled out based on a query. For example, data in table 112 represents the dollar value of the quantity sold for the quarters shown based on a query with filters on all years and quantity sold greater than 30,000.

Table 122 includes columns for dimensions “Year” 124 and “Quarter” 126 and a column showing measure 128 for the average dollar value of a quantity sold quarter wise for each year. A key of a table is a combination of one or more dimensions in the table. Source key 118 of table 112 includes dimension “Quarter” 114. Similarly, target key 130 of table 122 includes a combination of dimensions “Year” 124 and “Quarter” 126.

A target table may typically refer to one or more measures from a source table if the source key of the source table and the target key of the target table are on compatible flows. The keys are determined to be on compatible flows if the source key is included in or is equal to the target key. Table 122 (target table) may refer to measure 116 of table 112 (source table) and directly reference values of measure 116, as the source key 118 of table 112 and the target key 130 of table 122 are on compatible flows. The source key 118 and the target key 130 are determined to be on compatible flows as the dimension “Quarter” 114 of the source key 118 is included in the target key 130 as dimension “Quarter” 126. As seen in FIG. 1, table 122 refers to measure 116 in table 112 using the common dimension “Quarter” of the target key 130 as a look up key and uses values of measure 116 as measure 128 in table 122. In an embodiment, the values of measure 116 are included in measure 128 or table 122 as constants. These constants may further be used as desired, for example, in ratios for calculations.

In an embodiment, each column in a report table is provided with a unique name. Tables refer to each other using the unique names of the columns.

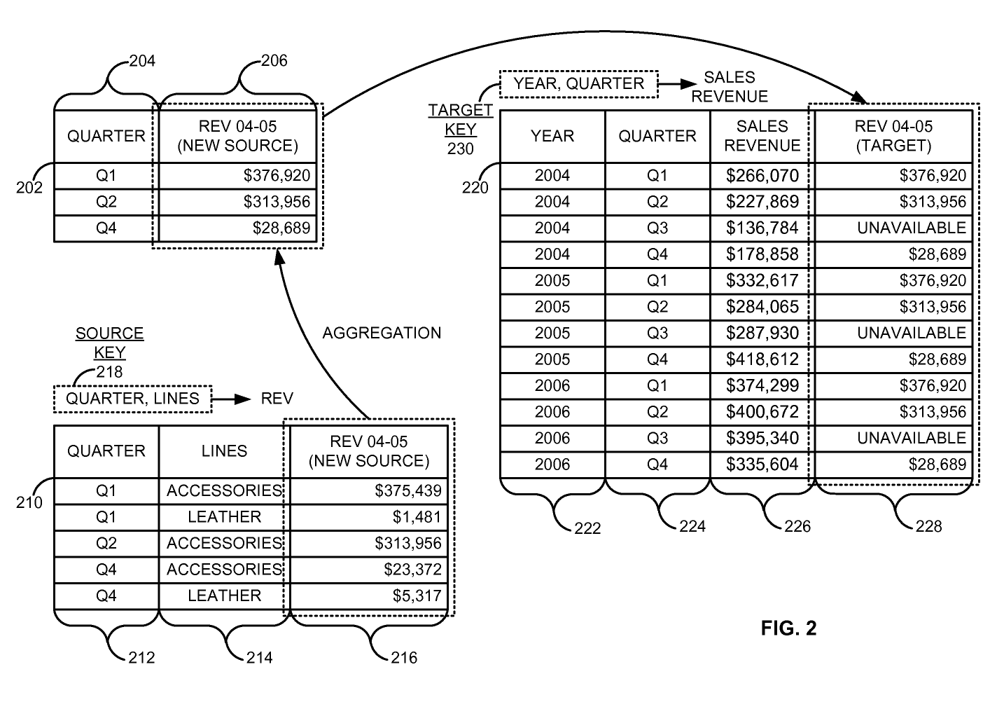

FIG. 2 illustrates referencing a measure between two tables of an analytical report document when the source key and the target key are not on compatible flows according to an embodiment of the invention. Source table 210 and target table 220 may be a part of a single or two separate analytical report documents. The source table 210 includes columns for dimension “Quarter” 212 and dimension “Lines” 214 and a column for measure “Revenue 04-05” 216. Similarly, the target table 220 includes columns for dimension “Year” 222 and dimension “Quarter” 224 and a column for measure “Sales Revenue” 226.

The source key 218 of the source table 210 includes dimensions “Quarter” 212 and “Lines” 214. The target key 230 of the target table 220 includes dimensions “Year” 222 and “Quarter” 224. A source key of a source table and a target key of a target table are determined to be on incompatible flows if at least one dimension in the source key of the source table is not included in the target key of the target table. The source table 210 and the target table 220 are on incompatible flows as the dimension “Lines” 214 of the source key 218 is not included in the target key 230.

A target table having a target key which is incompatible with the source key of a source table may not refer to the source table and use one or more measures from the source table until the source key is projected on the intersection of the source key and the target key, and the measures to be referenced are aggregated for all those dimensions of the source key that are not included in the target key. Thus, for the target table 220 to refer to the measure “Rev 04-05” 216 of the source table 210 and use the values of measure “Rev 04-05” 216, the source key 218 is projected on the intersection of the source key 218 and the target key 230 and the measure “Rev 04-05” 216 is aggregated for the dimension “Lines” 214. A temporary source table 202 is generated after the projection and aggregation in the source table 210 is completed. The source key of the temporary source table 202 is now on compatible flow with the target key 230 of the target table 220 as the dimension “Quarter” 204 of the temporary source table 202 is included in the target key 230 of the target table 220. This temporary source table 202 is then used for synchronization with the target table 220.

Target table 220 shows a column for measure “Rev 04-05” 228 using the values of aggregated measure “Rev 04-05” 206 referenced from the temporary source table 202. In an embodiment the values of measure “Rev 04-05” 228 in target table 220 act like constants and may be used for further calculations and incorporation in formulas.

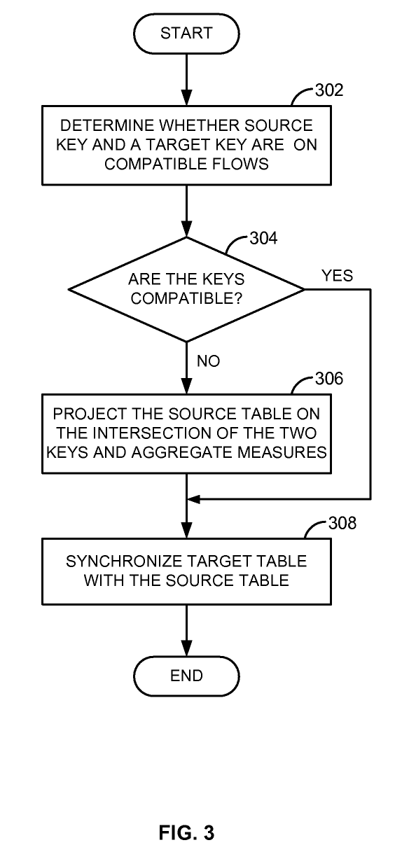

FIG. 3 illustrates a logic flow diagram illustrative of operations for referencing a measure between two tables of an analytical report document according to an embodiment of the invention. In process block 302, it is determined whether a source key of a source table and a target key of a target table are on compatible flows. A key of a table is a combination of one or more dimensions in the table. The source key of the source table and the target key of the target table are determined to be on compatible flows if the source key is included in or is equal to the target key. Alternatively, the source key and the target key are determined to be on incompatible flows if at least one dimension in the source key of the source table is not included in the target key of the target table. Determining whether the source key and the target key are on compatible flows includes comparing the dimensions of the source key with the dimensions of the target key and then determining the compatibility by matching each of the dimensions of the source key with the dimensions of the target key.

In decision block 304, if the source key is determined to be compatible with the target key, the process moves to process block 308 where the target table is synchronized with the source table. In an embodiment the target table refers to a measure from the source table using the target key as a look up key. A measure from the source table may be referenced in the target table if the source key and the target key are on compatible flows.

In decision block 304, if the source key is determined to be incompatible with the target key, the process moves to process block 306 where the source key is projected on to the intersection of the source key and the target key. The step of projecting includes aggregating one or more measures to be used in the target table for every dimension of the source key not included in the target key. The resulting table becomes the new source table for the next step.

In process block 308, the new source table and the target table are synchronized with each other. In an embodiment, a measure from the source table that is referenced in the target table may be fetched from the source table by a synchronization mechanism. A unique name is typically provided to every column in a table of the analytical report. In an embodiment every column in a table corresponds to a block formula. The values in each cell of the column are calculated using the block formula for the column. The target table references in its block formula one or more columns from the source table by referring to their unique name. In an embodiment, the target table refers to the source table by using the target key as a look up key.

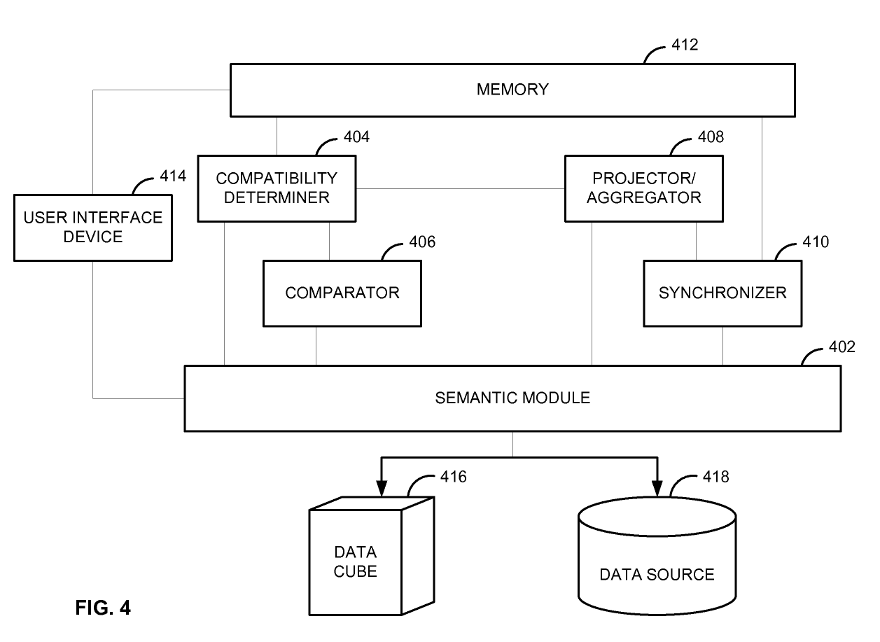

FIG. 4 depicts a pictorial representation of a data processing system which can be utilized in accordance with an embodiment of the invention. Semantic module 402 stores all data and metadata relevant to reports in an analytical report document. The semantic module 402 also stores one or more database schemas defining dependencies between dimensions and measures of every table in an analytical report document. Semantic module 402 may obtain the data from data cube 416 of a multi-dimensional database or from other data source 418 such as a relational database. Compatibility determiner 404 is responsible for determining whether a source key of a source table and a target key of a target table are on compatible flows or not. Comparator 406 is responsible for comparing every dimension of the source key with the dimensions of the target key. The compatibility determiner 404 determines the source key and the target key as being on compatible flows if the source key of the source table is included in or is equal to the target key of the target table. Alternatively, the compatibility determiner 404 determines the source key and the target key as being on incompatible flows if there is at least one dimension in the source key of the source table not included in the target key of the target table.

If the compatibility determiner 404 determines the source key as compatible with the target key synchronizer 410 synchronizes the target table with the source table.

If the compatibility determiner 404 determines the source key as incompatible with the target key, projector/aggregator 408 projects the source key on to the intersection of the source key and the target key. The step of projecting includes aggregating one or more measures to be used in the target table for every dimension of the source key not included in the target key. Once projector/aggregator 408 completes projection and aggregation operations, synchronizer 410 synchronizes the target table with the source table.

Memory 412 is responsible for temporarily storing data during the synchronizing of the target table with the source table. User interface device 414 provides an interface between a user and the system for receiving user requests.

The particular methods associated with embodiments of the invention are described in terms of computer software and hardware with reference to flowcharts. The methods to be performed by a computing device (e.g., an application server) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

Elements of the invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, or other type of machine-readable media suitable for storing electronic instructions. For example, the invention may be implemented as a method performed in a client-server network with the execution the methods distributed across the network.

It should be appreciated that reference throughout this specification to one embodiment or an embodiment means that a particular feature, structure or characteristic described in connection with the embodiment is included in at least one embodiment of the present invention. These references are not necessarily all referring to the same embodiment. Furthermore, the particular features, structures or characteristics may be combined as suitable in one or more embodiments of the invention.

Throughout the foregoing description, for the purposes of explanation, numerous specific details were set forth in order to provide a thorough understanding of the invention. It will be apparent, however, to one skilled in the art that the invention may be practiced without some of these specific details. For instance, the embodiments of the invention have been explained with respect to referencing measures between tables containing data. However, it should be understood that the embodiments of the invention equally apply to report blocks presenting data in other formats such as charts and other graphical representations. Furthermore, the detailed description as set forth above includes descriptions of method steps. However, one skilled in the art will understand that the order of the steps set forth above is meant for the purposes of illustration only and the claimed invention is not meant to be limited only to the specific order in which the steps are set forth. Accordingly, the scope and spirit of the invention should be judged in terms of the claims which follow.

What is claimed is:

1. A method for referencing measures between tables of analytical report documents, the method comprising:
determining whether a source key of a source table and a target key of a target table are on compatible flows, each of the source table and the target table comprising at least one dimension column and one measure column, the source key being a combination of one or more dimensions in the source table and the target key being a combination of one or more dimensions in the target table; and
upon determining that the source key and the target key are not on incompatible flows, performing the following:
projecting the source key on the intersection of the source key and the target key; and
synchronizing the target table with the source table.

2. The method of claim 1 wherein determining whether a source key of a source table and a target key of a target table are on compatible flows further comprises:
comparing the dimensions of the source key with the dimensions of the target key; and
determining the source key to be incompatible with the target key when at least one of the dimensions of the source key is not included in the dimensions of the target key;
determining the source key to be compatible with the target key if all the dimensions of the source key are included in or are equal to the target key.

3. The method of claim 1 further comprising on determining that the source key and the target key are on compatible flows, fetching one or more measures from the source table into the target table using the target key as a look up key.

4. The method of claim 1 wherein projecting the source key on the intersection of the source key and the target key further comprises aggregating a measure in the source table for every dimension of the source key not included in the target key.

5. The method of claim 4 wherein aggregating a measure in the source table further comprises aggregating the measure using an aggregation function.

6. The method of claim 1 wherein synchronizing the source table with the target table further comprises:
providing a measure in the source table with a unique name; and
referencing the measure into the target table using the unique name.

7. The method of claim 6 wherein referencing the measure into the target table further comprises referencing the measure using the target key as a look up key.

8. A system for referencing measures between tables of analytical report documents, the system comprising:
a compatibility determiner for determining whether a source key of a source table and a target key of a target table are on compatible flows, each of the source table and the target table comprising at least one dimension column and one measure column, the source key being a combination of one or more dimensions in the source table and the target key being a combination of one or more dimensions in the target table;
a projector for projecting the source key on the intersection of the source key and the target key on determining that the source and the target key are not on compatible flows; and
a synchronizer for synchronizing the target table with the source table.

9. The system of claim 8 further comprising a comparator coupled to the compatibility determiner for comparing the dimensions of the source key with the dimensions of the target key.

10. The system of claim 8 further comprising a semantic module for storing an analytical report data.

11. The system of claim 8 further comprising a memory for temporarily storing data during synchronization of the source table and the target table.

12. The system of claim 8 further comprising a user interface device for interfacing the system with a user.

13. A machine-accessible medium that provides instructions that, when executed by a machine, cause the machine to perform operations comprising:
determining whether a source key of a source table and a target key of a target table are on compatible flows, each of the source table and the target table comprising at least one dimension column and one measure column, the source key being a combination of one or more dimensions in the source table and the target key being a combination of one or more dimensions in the target table; and
upon determining that the source key and the target key are not on compatible flows, performing the following:
projecting the source key on the intersection of the source key and the target key; and
synchronizing the target table with the source table.

14. The machine-accessible medium of claim 13 wherein determining whether a source key of a source table and a target key of a target table are on compatible flows further comprises:
comparing the dimensions of the source key with the dimensions of the target key; and
determining the source key to be incompatible with the target key when at least one of the dimensions of the source key is not included in the dimensions of the target key;
determining the source key to be compatible with the target key if all the dimensions of the source key are included in or are equal to the target key.

15. The machine-accessible medium of claim 13 further providing instructions which when executed by the machine cause the machine to perform further operations comprising:
on determining that the source key and the target key are on compatible flows, fetching one or more measures from the source table into the target table using the target key as a look up key.

16. The machine-accessible medium of claim 13 wherein projecting the source key on the intersection of the source key and the target key further comprises aggregating a measure in the source table for every dimension of the source key not included in the target key.

17. The machine-accessible medium of claim 16 wherein aggregating a measure in the source table further comprises aggregating the measure using an aggregation function.

18. The machine-accessible medium of claim 13 wherein synchronizing the source table with the target table further comprises:
providing a measure in the source table with a unique name; and
referencing the measure into the target table using the unique name.

19. The machine-accessible medium of claim 18 wherein referencing the measure into the target table further comprises referencing the measure using the target key as a look up key.
